(19) United States
(12) Patent Application Publication
(10) Pub. No.: US 2006/0135649 A1
(43) Pub. Date: Jun. 22, 2006

(54) Aqueous coating agents

(75) Inventors: Rudolf Jedlicka, Wiener Neustadt (AT); Julius Burkl, Graz (AT); Markus Schafheutle, Graz (DE); Edmund Urbano, Graz (AT)

Correspondence Address: CONNOLLY BOVE LODGE & HUTZ, LLP, P O BOX 2207, WILMINGTON, DE, 19899, US

(73) Assignee: SURFACE SPECIALTIES AUSTRIA GMBH, WERNDORF (AT)

(21) Appl. No.: 10/543,552

(22) PCT Filed: Feb. 6, 2004
(86) PCT No.: PCT/EP04/01090

§ 371 Date: Jul. 27, 2005

(30) Foreign Application Priority Data
Feb. 6, 2003 (AT) A 186/2003

(51) Int. Cl. C09K 3/18; C08K 5/10

(52) U.S. Cl. 523/169; 524/315

(57) ABSTRACT

The invention relates to aqueous coating compositions with an anti-tarnish effect, containing a water-soluble or dispersed binding agent A and a compound B selected from fatty acid esters, containing hydroxyl groups of multivalent alcohols, and also to the use thereof for tarnish-protected glazings.

### FIELD OF THE INVENTION

The invention relates to aqueous coating materials.

### BACKGROUND OF THE INVENTION

Glass and transparent polymeric materials used in windows, mirrors, optical lenses, spectacle lenses, and face masks or protective shields fog up in the presence of atmospheric moisture below the dew point. Ultrafine water droplets deposit on the surface, considerably reducing the transparency.

It has been suggested to coat glass plates with certain polymers which have a high hydroxyl group content. From U.S. Pat. No. 5,075,133, coatings of polyvinyl alcohol have been known which comprise particular aluminum oxide particles. These reduce the transparency permanently. It has been known from U.S. Pat. No. 5,578,378 to coat glass plates with a mixture of acrylic monomers and to cure this mixture by irradiation with UV light. Methods of this kind can be employed only in the case of substrates on which these monomers do not cause partial dissolution or other damage, by the formation of stress cracks, for example. From JP 01-069 688 A it is known to admix a mixture of an aqueous emulsion of a resin based on vinyl acetate, styrene, acrylates, methacrylates, ethylene or vinyl chloride and a wax emulsion in a mass ratio of 98 to 50:2 to 50 with an additive which acts as an antifog agent, a poly-glycerol fatty acid ester, stearyl lactic acid or an alkanesulfonate, for example, in an amount such that a mass ratio of said mixture to the additive is 98 to 50:2 to 50. This mixture is applied to the surface of a plastic material and produces a good antifog effect, adhesion, injection moldability and low blocking propensity. Because of their wax content, however, mixtures of this kind give rise to turbidities, which are disruptive in the case of transparent substrates. Also known, from JP 53-018 641 A, is a coating material for polyolefin films which endows them with good slip properties, without blocking, namely a mixture of shellac and esters of sucrose and higher fatty acids. Coating materials of this kind are hydrophobic and cannot be incorporated into aqueous coating materials. JP 63 241 056 A, discloses antifog agents for injection-molded PVC articles that are the reaction product of a polyhydric alcohol, an alkylene oxide, a higher fatty acid and a dibasic acid or a cooligomer of (meth)acrylic acid. In connection with PVC, “fogging” is the term used to refer to the exudation of volatile plasticizers and their deposition on adjacent surfaces, such as on the inside of the windshield in an automobile. Suppressing the deposition of ultrafine water droplets on cooler surfaces is not known from this reference. In JP 56 043 383 A, resin compositions are described which act as antifog agents and prevent the fogging of a glass surface or optical-lens surface, involving the mixing of a substance having at least two polyoxyalkylene chains per molecule and a crosslinking agent with a surfactant. The mixture is applied to a body made of glass or a synthetic resin and is cured by heating at 50° C. to 200° C. for five minutes to 6 hours. In this case, use for heat-sensitive substrates is critical; also, it is not possible to treat substrates of large surface area, since they cannot be brought into the heating installations that are necessary. From U.S. Pat. No. 3,957,707 it is known to use an acrylic composition for producing films which do not block and do not fog up as a result of moisture exposure; 40 to 80 parts of alkyl (meth)acrylates are copolymerized with 20 to 60 parts of vinyl nitrites, and mixtures of compounding agents are used that comprise sorbitol mono-fatty acid esters and polyoxyethylene mono-fatty acid esters. The suitability of mixtures of this kind or similar mixtures for aqueous coating materials is not mentioned. JP 08 188 770, finally, discloses antifog agents for polymeric films, comprising mixtures of monoesters of fatty acids having 8 to 18 carbon atoms and polyhydric alcohols selected from sorbitol, 1,5-sorbitan, 1,4-sorbitan and isosorbitol with diesters of fatty acids having 8 to 18 carbon atoms and at least one polyhydric alcohol selected from sorbitol, 1,5-sorbitan, 1,4-sorbitan and isosorbitol, the mass ratio of monoester to diester being 3:7 to 9:1. None of the documents cited infers the possibility of such compounds being additives for aqueous coating materials in which physically drying, air-drying and self-crosslinking binders are employed. It is additionally known (EP-A 1 041 105) to treat films by corona discharge and then to coat them with certain hydrophilic additives such as esters of fatty acids with ethoxylated polyhydric alcohols (sugar alcohols). The corona treatment is costly and inconvenient and for continuous technical implementation is limited to substrates in film form.

### SUMMARY OF THE INVENTION

The object is therefore to provide a simplified process in order to provide not only ready-assembled, transparent sheets but also unformed transparent substrates, such as plates, for example, with a coating which prevents fogging, where substrates of any desired material may be treated.

In accordance with the invention the object is achieved by the use of an aqueous coating material with antifog effect comprising an aqueous solution or dispersion of a binder A and a compound B selected from hydroxyl-containing fatty acid esters of polyhydric alcohols, the binder A being selected from physically drying, air-drying and self-crosslinking binders.

The coating material can be applied directly to the substrate by one of the customary application methods, without it first being necessary to produce a film comprising a corresponding modifier.

### DETAILED DESCRIPTION OF THE PREFERRED EMBODIMENTS

Aqueous solutions or dispersions of binders A are preferably aqueous dispersions of polyurethanes, polyesters, epoxy resins, and polyacrylates; particular preference is given to aqueous dispersions of poly-urethanes. The solubility in water or dispersibility in water can be obtained through incorporation of hydrdphilic groups (self-emulsifying resins) or through addition of external emulsifiers (externally emulsified resins) . The binders suitable for the invention are those which form compact films without the addition of crosslinkers by evaporation of the solvent or dispersion medium (physically drying, air-drying or self-crosslinking binders). The binders can be cured by addition of additional crosslinkers such as polyfunctional isocyanates, amino resins, amines, polycarboxylic acids or anhydrides thereof, the choice of a suitable additional crosslinker being made in accordance with the functional groups of the binders. It is preferred to use coating materials which contain exclusively binders of the kind which form compact films without the addition of crosslinkers by evaporation of the solvent or dispersion medium (physically drying, air-drying or self-crosslinking binders) . Suitable self-crosslinking binders can be formulated by adding compounds, especially low molar mass compounds, to resins containing suitable functional groups, such as carbonyl groups (in the form of ketone groups or aldehyde groups), for example, the compounds added being preferably amines or hydrazine derivatives, especially dihydrazides of aliphatic dicarboxylic acids having preferably 4 to 20, more preferably 6 to 12, carbon atoms. Of course, the film formed must no longer be water-soluble and should also not undergo partial swelling by contact with water or moisture, and in that way become mechanically sensitive or lose its transparency. Such a loss of transparency occurs, for example, in the case of the mixtures known from the literature that comprise waxes or emulsions of waxes.

The compounds B are esters or mixtures of esters of polyhydric alcohols B1 with fatty acids B2, where on average preferably at least 0.2 hydroxyl groups more preferably at least 0.4 hydroxyl groups and in particular at least 0.6 hydroxyl groups per molecule of a polyhydric alcohol B1 remain unesterified. The polyhydric alcohols B1 have at least 2, preferably at least 3 and more preferably 4 to 6 hydroxyl groups per molecule. They contain 2 to 40 carbon atoms and are preferably aliphatic, linear, branched or cyclic alcohols. Preferred alcohols are glycol, glycerol, trimethylolpropane, trimethylolethane, erythritol, threitol, pentaerythritol, adonitol, arabitol, xylitol, sorbitol, dulcitol and mannitol, and in addition it is possible to use mixtures of these last-mentioned alcohols that are obtained during the reduction of sugars (sugar alcohols). In the context of the invention it is also possible, and preferred, to modify the alcohols by reaction with 1,2-epoxides such as oxirane, methyloxirane or mixtures thereof in such a way that they carry units of at least two successive oxyalkylene units. Preference is given here to an average of 2 to 40 oxyalkylene units per alcohol molecule.

Suitable fatty acids B2 include unsaturated and saturated fatty acids having 8 to 40 carbon atoms, preferably linear aliphatic monocarboxylic acids having 10 to 30 carbon atoms. Of particular suitability as saturated acids are myristic, palmitic, stearic, arachidic, behenic, lignoceric, cerotinic and melissic acid. It is also possible to use aliphatic dicarboxylic acids (those known as dimer fatty acids), which are obtained by dimerizing unsaturated fatty acids and have from 20 to 60 carbon atoms. Suitable unsaturated fatty acids are palmitoleic acid, oleic acid and erucic acid, sorbic acid and linoleic acid, and linolenic and eleostearic acid.

Monoesters of said acids B2 with trihydric to hexahydric alcohols having 3 to 6 carbon atoms are particularly suitable, especially those of tetrahydric to pentahydric alcohols, which as a result of reaction with ethylene oxide carry about 5 to 20 oxyethylene units per molecule, with saturated or monounsaturated fatty acids.

The coating materials of the invention preferably include a mass fraction of 0.1% to 50%, more preferably 0.2% to 10%, and in particular 0.25% to 5% of the compounds B, 2% to 98%, more preferably 5% to 80%, and in particular 10% to 70% of the binders A, if desired up to 20%, more preferably up to 10%, of a water-dilutable solvent, 0.1% to 98%, more preferably 0.5% to 80%, and in particular 1% to 70% of water. The mass ratio of the compound B to the mass of solids of the binder A is preferably from 0.1:9.9 to 3:7.

The coating compositions may further comprise customary additives for enhancing the wetting (substrate wetting agents), with particular preference in a mass fraction of from 0.1% to 5%, in particular from 0.2% to 1%, and defoamers in a mass fraction of more preferably from 0.1% to 2%, in particular from 0.2% to 1%. In this case the stated mass fractions add up to 100% obviously.

The coating materials can be applied by the customary methods such as spraying, rolling, brushing, and knife coating to any desired transparent substrates such as glass, polycarbonate, polyester carbonate, polyarylate, polyetherimide, polyether sulfone and polysulfone and also poly(meth)acrylates such as polymethyl methacrylate, poly(meth)acrylimides such as polymethylmethacrylimide and other acrylate glasses, and are solidified to a transparent film. The surfaces treated therewith do not fog up when they come into contact with atmospheric moisture and are brought to a temperature below the dew point for the humid air. The films produced therewith are not attacked by moisture; in particular there is no reduction in the desired effect on prolonged contact with atmospheric moisture as a result of removal of the modifier B by washing. Particularly when polyurethanes are used as binders, it has been found that the binding of the modifier in the film produced by coating efficiently suppresses leaching. The transparent substrates thus treated can therefore be employed with great advantage for all kinds of glazing.

The examples below illustrate the invention.

### EXAMPLE 1

A polyurethane dispersion was used, in accordance with the table below, to prepare an inventive coating material from a binder A and a compound B (antifog agent). The mass fractions of each of the solids in the coating material are indicated.

Table Composition of the coating material in % (g/100 g)
Polyurethane⁴ 62.25%
Antifog agent¹ 1.99%
Methoxypropanol 1.99%
Wetting agent² 0.33%
Defoamer³ 0.33%
   Total 66.89%
Water 33.11%
1 Ethoxylated sorbitol monoesterified with oleic acid (20 mol of oxyethylene units per 1 mol of sorbitol)
2 ®Byk 346, wetting agent
3 ®Additol XW 376, defoamer
4 ®Daotan VTW 6462, aqueous polyester-urethane dispersion having a mass fraction of solids of 36%, Surface Specialties Austria GmbH

The stated constituents were mixed with a high-speed stirrer for 5 minutes.

### EXAMPLE 2

Three stripes of the coating material prepared in accordance with example 1, with a dry film thickness of 7 μm, were applied alongside one another to a polycarbonate sheet (layer thickness 0.45 mm). The coated sheet was dried at 80° C. for 30 minutes.

### EXAMPLE 3

A polycarbonate sheet as in example 2 was surface-activated by corona discharge and coated with an aqueous solution of the antifog agent specified in example 1. The application rate was chosen so that the mass of the antifog agent was the same relative to the area of the polycarbonate sheet. The coated sheet was dried as in example 2.

### EXAMPLE 4

The sheets from examples 2 and 3 were placed at room temperature (22° C.) at an angle of 60° over a tank containing distilled water which had been heated to 30° C. After just a short time, condensation drops were formed on the uncoated areas of the sheets, running parallel to the stripes on the sheets. On the coated stripes, one large drop was formed in each case only in the lower region. After two days it was observed that small condensation droplets had formed even on the coated areas of the sheet from example 3. After a further two days, the sheet from example 3 was uniformly covered with condensation droplets. On the sheet from example 2, condensation droplets were visible only on the uncoated areas between the coated stripes on the sheet. Even after 20 days of observation no droplet formation was visible on the coated stripes; all that was formed, as at the beginning of the experiment, was one large drop in the lower region. After this, the experiment was discontinued.

While the coating was effective as an antifog coating, the coated stripes in contact with the moist air remained transparent. Apparently the coating of the sheet in example 3 was gradually washed away by the condensed water, while the activity of the antifog agent bound inventively in the binder film remained unchanged.

1. An aqueous coating material with antifog effect, comprising an aqueous solution or dispersion of a binder A and a compound B selected from hydroxyl group-containing fatty acid esters of polyhydric alcohols.

2. The aqueous coating material of claim 1, characterized in that the ratio of the mass of compound B to the mass of solids of the binder A is from 0.1:9.9 to 3:7.

3. The aqueous coating material of claim 1, characterized in that the binder A comprises an aqueous dispersion of resins selected from the group consisting of polyurethanes, polyesters, epoxy resins, and polyacrylates.

4. The aqueous coating material of claim 1, characterized in that the binder A is physically drying, air-drying or self-crosslinking.

5. The aqueous coating material of claim 4, characterized in that the binder A comprises an aqueous solution or dispersion of a resin containing carbonyl groups, and a dihydrazide of an aliphatic dicarboxylic acid.

6. The aqueous coating material of claim 1, characterized in that the compound B is an ester of a polyhydric alcohol B1 with a fatty acid B2, on average at least 0.2 hydroxyl group per molecule of the polyhydric alcohol B1 remaining unesterified.

7. The aqueous coating material of claim 6, characterized in that the polyhydric alcohols B1 have two to six hydroxyl groups per molecule.

8. The aqueous coating material of claim 6, characterized in that the polyhydric alcohols B1 have been modified by reaction with 1,2-epoxides.

9. The aqueous coating material of claim 6, characterized in that the fatty acids B2 are selected from the group consisting of saturated and monounsaturated linear aliphatic monocarboxylic acids having 10 to 30 carbon atoms.

10. The aqueous coating material of claim 6, characterized in that the compounds B are monoesters of ethoxylated aliphatic trihydric to hexahydric alcohols B1 having 3 to 6 carbon atoms and from 5 to 20 oxyethylene units per molecule.

11. A process for producing fog-protected glazing comprising a transparent substrate and a film deposited thereon, characterized in that the aqueous coating material of claim 1 is applied to a transparent substrate and a film is formed on the substrate by crosslinking.

12. Fog-protected glazing obtained by the process of claim 11.
